(19) United States
(12) Patent Application Publication
(10) Pub. No.: US 2009/0094107 A1
(43) Pub. Date: Apr. 9, 2009

(54) Enhanced Ad-Wrapped Applications for Mobile and Other Computing Devices

(76) Inventors: Cary Torkelson, Allendale, NJ (US); Stephen T. Dacek, Rockville Center, NY (US); Arthur A. Goikhman, Morganville, NJ (US)

Correspondence Address: FISH & RICHARDSON P.C., P.O. BOX 1022, MINNEAPOLIS, MN, 55440-1022, US

(21) Appl. No.: 11/869,476

(22) Filed: Oct. 9, 2007

(51) Int. Cl. G06Q 30/00; G06F 17/40; G06F 19/00

(52) U.S. Cl. 705/14

(57) ABSTRACT

An application, executing on a mobile or other computing device, which has been subject to wrapping technology, provides the wrapper with the ability to insert logos, banners, and other advertising material, and allows that advertising information to be displayed within the wrapped application, not just before and after execution of the application. By having the wrapper specify the advertising images and data to be used, the in-application advertisements can complement the advertisements the wrapper displays before and after the application is executed.

### BACKGROUND

The present disclosure relates to ad-wrapped applications for mobile and other computing devices.

In the present context, wrapping refers to the process by which an application is modified by an advertisement service provider or other agency which typically was not responsible for developing the application being wrapped. Modification of the application results in the addition of code developed by the wrapping service that hooks into the application such that the additional code is executed before and/or after the original application executes.

Ad-wrapping technologies allow service providers to wrap advertisements around an existing third-party application designed for execution on a mobile or other computing device. Such technologies can provide a revenue stream to the third-party application by enabling advertising before and after the application is executed. Examples of mobile computing devices to which ad-wrapping technologies can be applied include mobile phones, smart phones, personal digital assistants (PDAs), and laptop computers.

In general, wrapping is accomplished by hooking in to the original application, which gives the entity responsible for writing the wrap code the ability to execute its own code before and/or after the original application is executed on the mobile or other computing device.

### SUMMARY

The present disclosure describes techniques that allow third-party applications executing on mobile or other computing devices, which have been subject to wrapping technology, to provide the wrapper with the ability to insert logos, banners, and other advertising material to be displayed within the application that was wrapped, not just before and after execution of the application. The techniques also allow a wrapper to obtain statistics about how often an advertisement was displayed, the level of user interest, user input, or other metrics that may be useful to the wrapper. By having the wrapper specify the advertising images and data to be used, the in-application advertisements can complement the advertisements the wrapper displays before and after the application is executed.

The foregoing capabilities are accomplished by having the application indicate to a potential wrapper that it can support wrapper-directed placement of in-application ads by using a wrap extension capabilities file (WECF) included in the application's build package. The WECF can be read and modified by the wrapper during the wrapping process. The modified WECF then is used by the application to know that it had been wrapped, and the details under which the wrapper wishes to place in-application ads and have the use of those ads reported.

The wrapper can specify the content used for in-application advertising via one or more of several methods. In a first approach, the application or wrapper specify a shared data store on the device which both the wrapper and application can access. The wrapper stores advertising images and other data in the shared data store for use by the application. The application stores ad-related metrics, user interest, or user input in the shared data store for use by the wrapper when reporting such information to the advertisement service.

In a second approach, the wrapper uses the shared data store to indicate to the application how it can obtain advertising images and data directly from the ad service, and how the application can report ad-related metrics, user interest, or user input directly to the ad service. The wrapper can modify these entries in the shared data store each time the application is executed.

A third approach does not require a shared data store. The wrapper provides the information to be used by the application to obtain advertising images and data directly from the advertisement service, and information as to how the application can report ad-related metrics, user interest, or user input directly to the advertisement service, by modifying the WECF during the wrapping process and including such details at that time.

Various aspects of the invention are recited in the claims.

Other features and advantages will be readily apparent from the following detailed description and the accompanying drawings.

### BRIEF DESCRIPTION OF THE DRAWINGS

FIGS. 1A, 1B an 1C illustrate a process by which a third-party application can be executed on a mobile device.

FIGS. 2A, 2B, 2C, 2D and 2E illustrate a process by which a wrapped application can be executed on a mobile device.

FIGS. 3A, 3B, 3C, 3D and 3E illustrate a process by which a wrapped application is executed on a mobile device in accordance with the invention.

FIG. 4 illustrates a wrapping process in accordance with the invention.

FIG. 5 illustrates an example for storing and retrieving advertising related information in accordance with the invention.

FIG. 6 illustrates another example for storing and retrieving advertising related information in accordance with the invention.

FIG. 7 illustrates a further example for storing and retrieving advertising related information in accordance with the invention.

### DETAILED DESCRIPTION

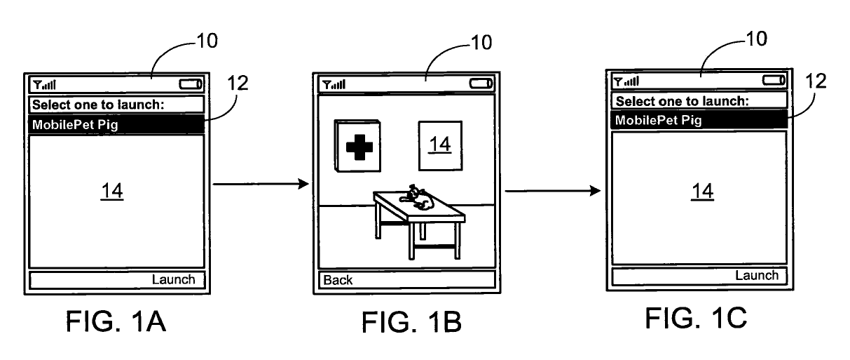

FIG. 1 illustrates how a typical third-party application is selected to be executed, and subsequently interacted with, on a mobile or other computing device 10. First, the user chooses a third-party application to execute from a list 12 that appears on the display screen 14 of the computing device (FIG. 1A). Once the user selects the application, the device executes the selected application (see FIG. 1B), during which time the user may be able to interact with the third-party application. After the user has completed interacting with the application, the user exits the application and is returned to the application list 12 (see FIG. 1C). If, during execution, the application is to display advertising of any form to the user, the application would need to contain custom code and data to do so. In addition, the application is responsible for interacting with an advertising server in order to customize the advertisements, to allow the user to interact with the advertisements, and to report advertisement metrics.

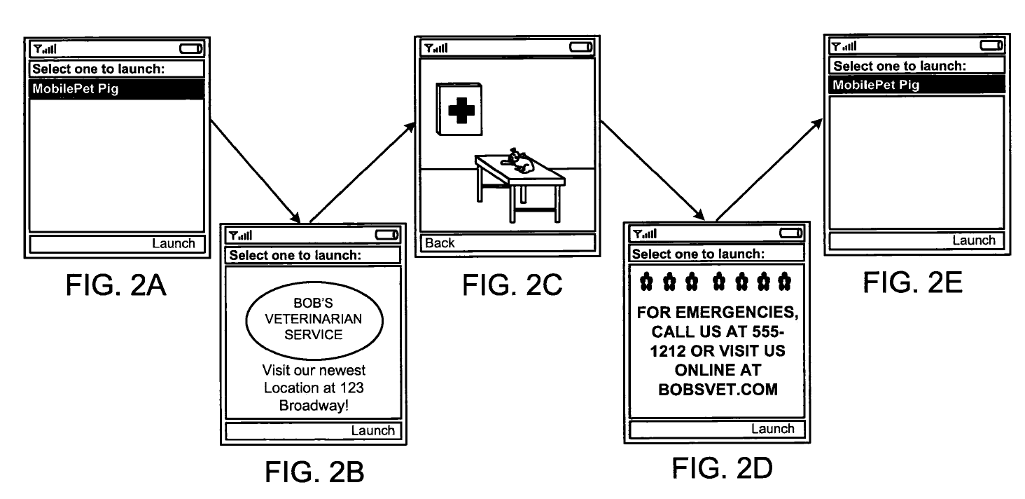

As shown in FIG. 2, an application that has been wrapped with an ad-wrap technology allows advertising to be shown without the need for the third-party application developer to create and include specialized code, or to make arrangements with and interact with an advertising service agency. The ad-wrapper contains the custom advertising code and handles any interactions with an advertising service agency. When a user selects an ad-wrapped application (FIG. 2A) for execution by the mobile device, the wrap code takes control before the actual application is executed. In various implementations, the wrap code can show an advertisement, connect to the advertising server, and allow the user to interact with the advertisement (FIG. 2B). Once the advertisement is completed, control is returned to the original application, which then executes and interacts with the user (FIG. 2C). When the user chooses to exit the application, the wrap code again takes control and can present the user with another advertisement, connect to the advertising agency and allow the user to interact with the advertisement (FIG. 2D). After the advertisement is completed, program execution completes and the display screen returns to the application list (FIG. 2E).

An advantage of such ad-wrapping technology is that the application developer does not need to write custom code or make arrangements to connect to an advertisement service provider in order to show advertisements within the application. The ad wrapper takes care of this for the application developer. A disadvantage to this approach, however, is that advertisements can be shown only before and after the application itself is executed. Advertisements cannot be shown during the actual program's execution. Although the application developer can create the custom code and make the necessary arrangements with an advertisement service provider to support advertisement display during the original program's execution, such advertisements would not necessarily be coordinated with, or complimentary to, the advertisements that the wrapper is showing. In such cases, the ad wrapper has no control over the content that the application uses.

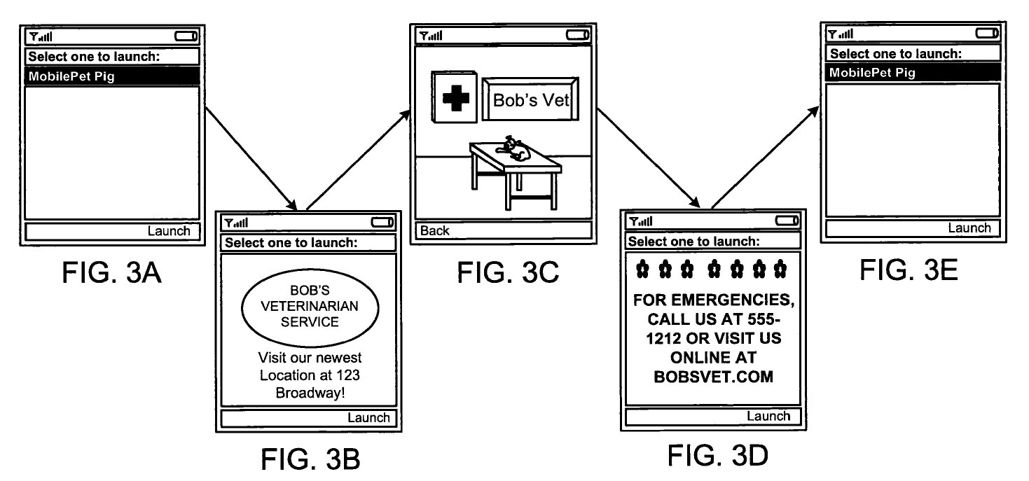

FIG. 3 illustrates a more integrated approach in which advertisements can be shown during the execution of the application, where the advertisements are controlled by and coordinated with the advertisements that are shown by the ad wrapper before and after the application is executed. In this situation, the application does not need to include custom code to obtain advertisements from an advertising network. Instead, the ad wrapper code itself either obtains, or indicates to the application how to obtain, advertisements that are complimentary to the advertisements shown before and after the application executes. The application then can show these coordinated advertisements at appropriate times during program execution.

When a user selects an ad-wrapped application for execution by the mobile device (FIG. 3A), the wrap code takes control before the actual application is executed. In various implementations, the wrap code can show an advertisement, connect to the advertising server, and allow the user to interact with the advertisement (FIG. 3B). Once the advertisement is completed, control is returned to the original application, which then executes and interacts with the user. In this case, however, advertisements or other information obtained by the wrap code, or specified in a special file and obtained by the application, are displayed in the application (FIG. 3C). When the user chooses to exit the application, the wrap code again takes control and can present the user with another advertisement, connect to the advertising agency and allow the user to interact with the advertisement (FIG. 3D). After the advertisement is completed, program execution completes and the display screen returns to the application list (FIG. 3E).

To facilitate the coordination and integration of advertising driven by the wrap code, an application that supports such functionality can notify the ad-wrapper of such capabilities through use of a special file that the ad-wrapper examines and can modify during the ad wrapping process. In this disclosure, the special file is sometimes referred to as a wrap extension capabilities file (WECF) and is a file that a third-party application developer can include in its application package. Through use of the WECF, the application informs the wrapper about what in-application advertising the application is capable of, and provides information as to what advertisement formats are supported, where to store advertisement images, data, and other advertising information for use by the application while it is executing, and what reporting methods can be used. The wrapper can modify the WECF during the wrapping process to inform the application that it has been wrapped, and to inform the application as to what extensions the wrapper plans to utilize and how those extensions will be utilized. After wrapping, the WECF can be read by either the wrap code or the application during execution, but typically cannot be modified by either.

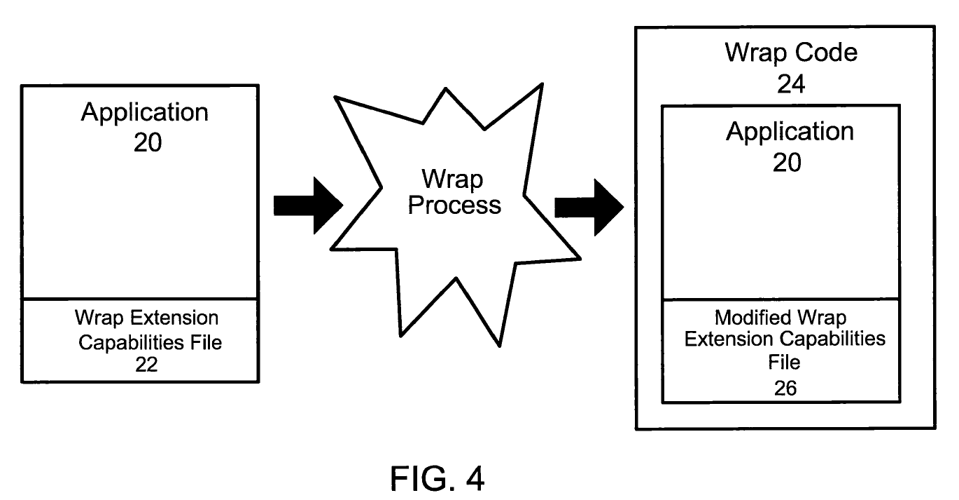

FIG. 4 illustrates how the WECF is used during the wrapping process. In particular, the ad-wrapper examines the application package 20 during the wrap process to determine if the application supports ad-wrap extensions via a WECF, If a WECF 22 is present, the wrapper examines the file to determine which advertisement integration capabilities supported by the application are of interest to the ad-wrapper. The capabilities specified by the WECF can include, but are not limited to the following:
The type of advertisement images supported, such as PNG, GIF, JPEG, animated GIF, or other formats.
Characteristics of the locations where the application can display advertisements, such as the size of the advertisement, whether it is a full-screen advertisement, a click-through advertisement, or an advertisement that is displayed for a specific length of time, the prominence of the advertisement on the screen such as in the foreground, in the background, a banner ad, or integrated into the application's display of data.
The location and format of a shared application data store from which advertisements can be obtained, and advertisement metrics stored.
The ability of the application to contact an advertisement server directly to obtain advertisements or to report advertisement usage metrics.
The ability of the application to allow the user to interact with an advertisement (e.g., click on an advertisement to obtain additional information concerning the item advertised).
The ability of the application to obtain input from the user related to an advertisement being displayed.
The types of advertisement metrics tracked, such as impressions and duration displayed on the screen.

During the wrap process, the wrapper can modify the WECF to indicate to the application that is has been wrapped and to indicate which methods of integration the wrapper intends to use. During execution, the application 20 can examine the modified WECF 26 to determine if it has been wrapped, and what integration capabilities the wrapper is utilizing. The application 20 can obtain instructions from the modified WECF about how and where to place integrated advertisements, and how and where to report advertisement usage metrics. For some platforms, such as mobile devices operating in a J2ME environment, the WECF has a read-only status during program execution. That means that the wrapper can modify the WECF file only during the ad-wrap process itself, not afterwards when the wrap code is being executed.

Alternatively, the wrap code can utilize a shared data store specified in the WECF to indicate to the application what advertisement integration services it plans to utilize, and how they should be used by the application. The advantage to using the shared data store is that it can be read and written to during program execution. This gives the ad wrap code, as well as the application code, the ability to modify those instructions at any time.

There are a number of ways that the ad-wrapper and the application can work together to provide seamless advertisement integration. Three approaches are described in greater details below as examples of methodologies. However, other methodologies can be designed and implemented using the techniques introduced in this disclosure.

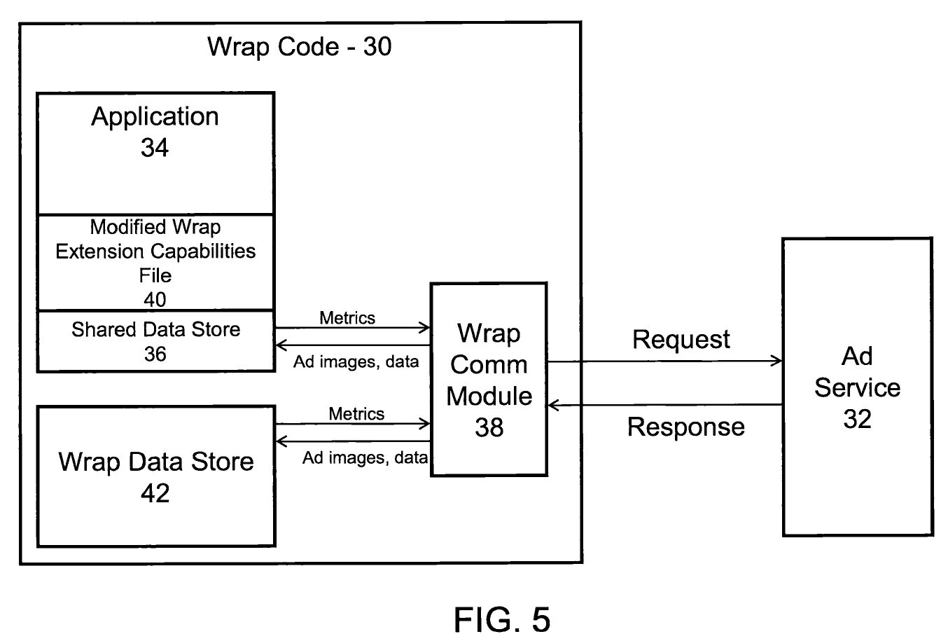

One implementation is illustrated in FIG. 5. This implementation requires minimal additional coding by the third-party application developer because the wrap code 30 takes care of communications with the advertisement service provider 32, and makes decisions as to what advertisement images to display. The application 34 simply examines the shared data store 36 for advertisement images that are to be displayed, and report back usage metrics. A wrap communication module 38 is contained within the wrap code 30 and is responsible for communications to the advertisement service 32 or other service providers. During wrap code execution, the wrap communication module 38 can report advertisement metrics stored by the application in the shared data store 36 back to the advertisement service 32, and obtain advertisement images and data from the advertisement service to be stored and later used by the application 34 while it is executing. The advertisements retrieved can be complimentary to those that are displayed by the wrap code 30 while it is executing. An example of the flow is discussed in the following paragraphs.

Initially, a user of the mobile or other device selects the wrapped application 34 for execution. Next, the wrap code 30 takes initial control and contacts the advertisement service 32 for advertisements and other data to be displayed immediately to the user. In some cases, the wrap code 30 may use advertisement information previously obtained from the advertisement service 32 during a prior execution and, thus, not contact the advertisement service at this point. Previously obtained advertisement information can be stored, for example, in a separate store (i.e., memory) 42 on the device. The wrap code 30 causes one or more advertisements to be displayed to the user and can allow user interaction with the advertisements as needed. The wrap code 30 reports back usage metrics and user data, if obtained, to the advertisement service 32. In some cases, the wrap code 30 may save this data in the separate store 42 for reporting to the advertisement service 32 at a later time. The wrap code 30 reads the WECF 40 and shared data store 36 to determine the integration features supported by the application. In some cases, the wrap code 30 reads advertisement metrics, user input, and other relevant data placed by the application 34 into the shared data store 36 and reports that information to the advertisement service 32. In some cases, the wrap code 30 obtains advertisements and other data from the advertisement service 32 based on the application's features, and stores that information in the shared data store 36 at a predetermined location accessible by the application 34.

The application 34 then executes and examines the shared data store 36 for advertisement images and other data that can be used while the application is executing. During execution, the application 34 incorporates advertisements and other advertisement data where appropriate. The application 34 can also store advertisement usage metrics, information collected from the user, and other relevant data in the shared data store 36.

Once the user exits the application, the wrap code 30 re-takes control and contacts the advertisement service 32 for advertisements and data to be displayed immediately to the user. Again, the wrap code 30 may, in some cases, use advertisement information previously obtained from the advertisement service 32 during a prior execution and not contact the advertisement service at this point. The wrap code 30 displays one or more advertisements to the user and can allow user interaction with the advertisements. The wrap code 30 reports back usage metrics and user data, if obtained, to the advertisement service 32. Again, the wrap code 30 may, in some cases, cache this data in the separate data store 42 for reporting to the advertisement service 32 at a later time. The wrap code 30 reads the WECF 40 and the shared data store 36 to determine the integration features supported by the application 34. The wrap code 30 can read advertisement metrics, user input, and other relevant data placed by the application 34 into the shared data store 36 and report that information to the advertisement service 32. Execution of the application 34 then ends.

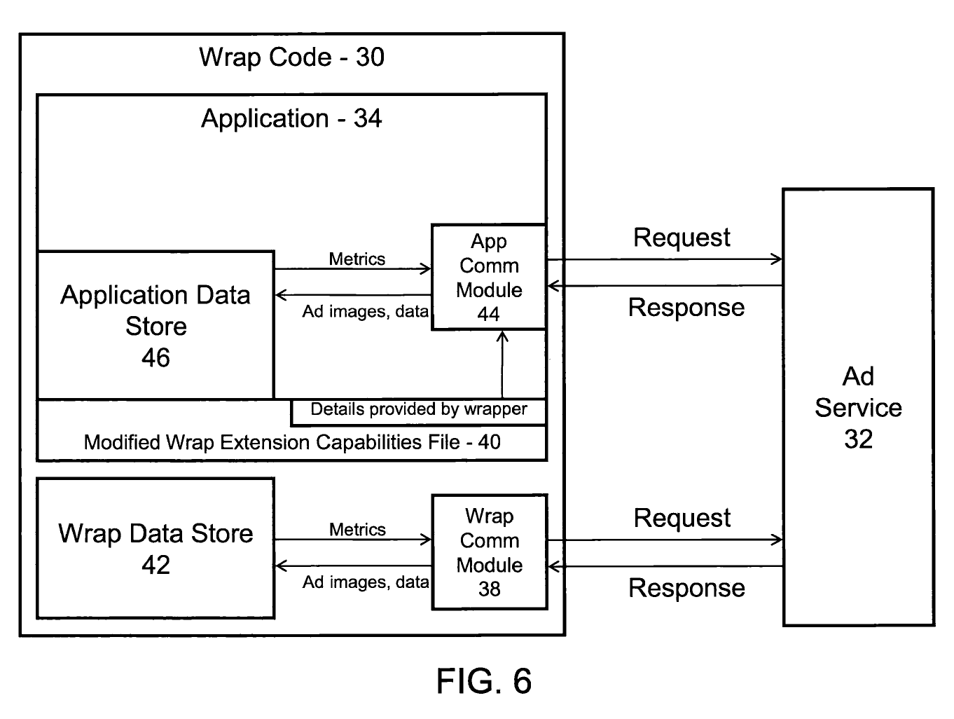

Another implementation is illustrated in FIG. 6. An advantage of this implementation is that a shared data store need not be used. In this case, the application 34 is responsible for contacting the advertisement service 32 directly, and the details on how to do so are stored in the WECF 40 by the ad-wrapper during the wrapping process. In this implementation, the advertisement service 32 maintains a listing of the types of advertisements displayed by the wrap code 30 before the application is executed, and sends complimentary advertisements to the application 40 when it contacts the advertisement service 32 during execution. This can be accomplished by storing a unique identifier in the WECF 40 during the wrap process; both the wrap code 30 and the application code 34 use the unique identifier when contacting the advertisement service 32. Communications between the wrap code 30 and the advertisement service 32 takes place through a wrap communication module 38. Communications between the application 34 and the advertisement service 32 or other outside service provider take place through an application communication module 44. An example of the flow is described in the following paragraphs.

Initially, a user of the mobile or other device 10 selects the wrapped application 34 for execution. The wrap code 30 takes control and reads the unique identifier from the WECF 40 for use when contacting the advertisement service 32. The wrap code 30 then contacts the advertisement service 32 using the unique identifier from the WECF to obtain advertisements and other data to be displayed immediately to the user. The wrap code 30 can, in some cases, use advertisement information obtained by the advertisement service 32 during a prior execution and not contact the advertisement service at this point. The wrap code 30 displays one or more advertisements to the user and can allow user interaction with the advertisements as needed. The wrap code 30 can report back usage metrics and user data, if obtained, to the advertisement service 32. The wrap code 30 can, in some cases, cache this data in the wrap data store 42 for reporting back to the advertisement service 32 at a later time. The advertisement service 32 records the current advertisement set that the wrap code 30 most recently obtained from the service so that advertisements requested by the application 34 can be coordinated and complimentary to those displayed by the wrapper.

Next, the application 34 executes and reads the unique identifier, as well as other instructions on how the application can contact the advertising service 32, from the WECF 40 for use when contacting the advertisement service 32. The application 34 contacts the advertisement service 32 using the unique identifier from the WECF 40 to obtain advertisements and other data to be displayed to the user while the application is executing. The application code can, in some cases, use advertisement information obtained from the advertisement service 32 during a prior execution and not contact the advertisement service at this point. Such information can be stored in an application data store 46.

In some implementations, the wrapper may have specified the details as to when to obtain new advertisements and when to use cached advertisements stored in the WECF 40. If so, the application 34 would use that data to determine when to contact the advertisement service 32.

The application 34 displays one or more advertisements to the user during program execution, and can allow user interaction with the advertisements as needed. The application 34 then reports back usage metrics and user data, if obtained, to the advertisement service 32. The application code 34 can, in some cases, cache this data in the application data store 46 for reporting back to the advertisement service 32 at a later time. The wrapper may, in some cases, have specified the details as to when to report metrics and when to cache metrics in the WECF 40. If so, the application 34 would use that data to determine when to contact the advertisement service 32.

The advertisement service 32 records the current advertisement set that the application 34 most recently obtained from the service, so that advertisements requested by the wrap code 30 can be coordinated and complimentary to those displayed by the application.

Once the user exits the application, the wrap code 30 re-takes control and reads the unique identifier from the WECF 40 for use when contacting the advertisement service 32. The wrap code 30 contacts the advertisement service 32 using the unique identifier from the WECF, for ads and data to be displayed immediately to the user. Note that the wrap code 30 may choose to use ad information obtained by the ad service during a prior execution and not contact the ad service at this point. The wrap code 30 displays one or more advertisements to the user, and can allow user interaction with the advertisements as needed. The wrap code 30 reports back usage metrics and user data, if obtained, to the advertisement service 32. Again, the wrap code 30 can, in some cases, cache this data in the wrap data store 42 for reporting back to the advertisement service 32 at a later time.

The advertisement service 32 records the current advertisement set that the wrap code 30 most recently obtained from the service so that advertisements requested by the application 34 can be coordinated and complimentary to those displayed by the wrap code 30. Execution of the application 34 then ends.

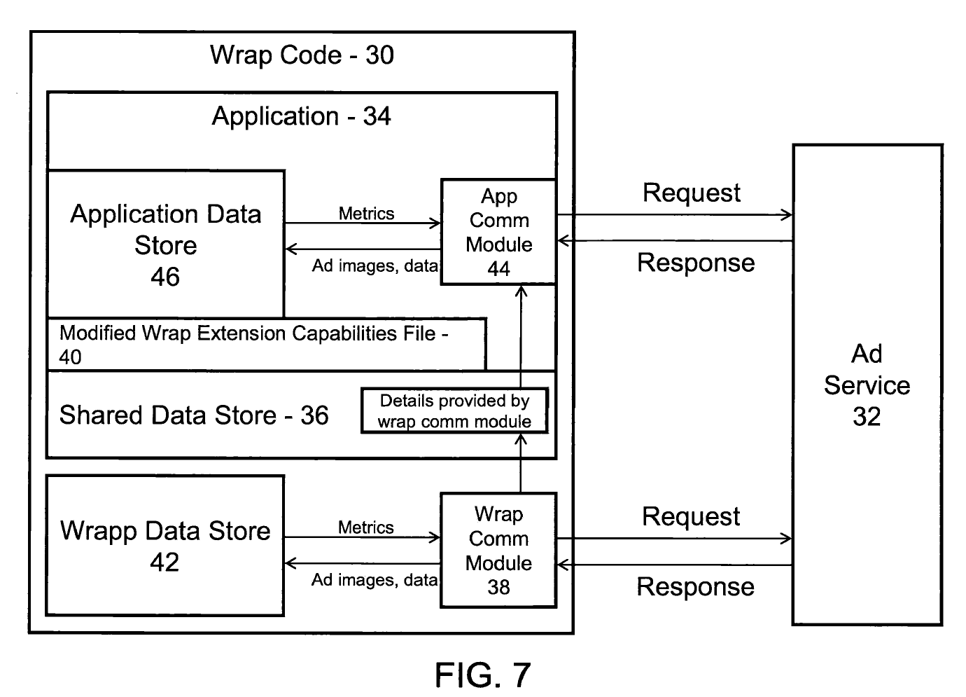

Another example is illustrated in FIG. 7. This implementation combines techniques from the implementations described above in connection with FIGS. 5 and 6. A shared data store 36 is used, but the application 34 is also responsible for contacting the advertisement service 32. One advantage of this implementation is that the advertisement service 32 does not necessarily need to keep track of what advertisements it has sent to the wrap code 30 or the application 34 because the wrap code and application can update the shared data store 36 with information provided by the advertisement service regarding to what kinds of advertisements should be retrieved next. Another advantage of using the shared data store 36 is that it can be modified during execution of the wrap code 30 or application program 34. This provides additional flexibility as compared to the read-only WECF. The wrap code 30 can change the way and means by which the application 34 contacts the advertisement service 32 by making changes to the information in the shared data store 36. This implementation also can reduce the amount of data stored in the shared data store 36 because only the instructions for obtaining advertisements need to be stored; the advertisements themselves need not be stored. An example of a flow using the implementation of FIG. 7 is described in the following paragraphs.

Initially, a user selects the wrapped application 34 for execution. The wrap code 30 takes initial control and contacts the advertisement service 32 for advertisements and data to be displayed immediately to the user. The wrap code 30 can, in some cases, use advertisement information obtained from the advertisement service 32 during a prior execution and not contact the advertisement service at this point. The wrap code 30 displays one or more advertisements to the user, and can allow user interaction with the advertisements as needed. The wrap code 30 also reports back usage metrics and user data, if obtained, to the advertisement service 32. The wrap code 30 can, in some cases, cache this data in the wrapper data store 42 for reporting back to the advertisement service 32 at a later time. The wrap code 30 reads the WECF 40 and shared data store 36 to determine the integration features supported by the application 34. If necessary, the wrap code 30 stores instructions on how and where to obtain advertisements from the advertisement service 32 in the shared data store 36 for the application 34 to use when it is executing. These instructions can be obtained from the advertisement server 32, either through a special request by the wrap code 30, or previously when the wrap code 30 contacted the advertisement server 32 to obtain advertisements and/or report usage metrics.

Next, the application 34 executes and contacts the advertisement service 32, based on the instructions stored by the wrap code 30 in the shared data store 36, for advertisements and data to be displayed to the user while the application is executing. The application code 34 can, in some cases, use advertisement information obtained from the advertisement service 32 during a prior execution and not contact the advertisement service at this point. The wrap code 30 may, in some cases, have specified the details as to when to obtain new advertisements and when to use cached advertisements in the shared data store 36. If so, the application 34 would use that data to determine when to contact the advertisement service 32. The application 34 then displays one or more advertisements to the user during program execution, and can allow user interaction with the advertisements as needed. The application 34 reports back usage metrics and user data, if obtained, to the advertisement service 32. Again, the application code 34 can, in some cases, cache this data in the application data store 46 for reporting back to the advertisement service 32 at a later time. The adwrap code 30 may, in some cases, have specified the details as to when to report metrics and when to cache metrics in the shared data store 36. If so, the application 34 would use that data to determine when to contact the advertisement service 32.

Once the user exits the application, the wrap code 30 re-takes control and contacts the advertisement service 32 for advertisements and data to be displayed immediately to the user. The wrap code 30 can, in some cases, use advertisement information obtained from the advertisement service 32 during a prior execution and not contact the advertisement service at this point. The wrap code 30 displays one or more advertisements to the user and can allow user interaction with the advertisements as needed. The wrap code 30 then reports back usage metrics and user data, if obtained, to the advertisement service 32. Again, the wrap code 30 can, in some cases, cache this data in the wrapper data store 42 for reporting back to the advertisement service 32 at a later time. Execution of the application 34 then ends.

Various features can be implemented in hardware, software, or a combination of hardware and software. Software code containing instructions for implementing various of the functions described above can be stored in memory residing on the mobile or other computing device. The advertising service 32 can be implemented as a server which may have one or more associated databases. Communications between the mobile or other computing device typically can be wireless communications. However, for some computing devices, communications can take place over other media.

The foregoing techniques can allow ad-wrap technology to be enhanced so as to provide a richer, more unified advertising experience to users of ad wrapped applications. By providing this more unified experience, advertisements can be made more effective and less obtrusive to the user, increasing the value of such advertising to the third-party application developer and the ad wrapping agency alike.

Other implementations are within the scope of the claims.

What is claimed is:

1. A method of displaying advertisement information on a computing device, the method comprising:
performing an advertisement wrapping process with respect to an application prior to installation on the computing device;
examining contents of a file, which is associated with the application, during the advertisement wrapping process; and
modifying contents of the file during the advertisement wrapping process to make additional advertisement information available to the application during execution on the computing device.

2. The method of claim 1 wherein the application and the file are part of the same application package.

3. The method of claim 2 wherein an ad-wrapper performing the advertisement wrapping process examines the contents of the file, and modifies the contents of the file to make the additional advertisement information available to the application during execution.

4. The method of claim 1 wherein the file specifies the types of advertisement images supported by the application.

5. The method of claim 1 wherein the file specifies characteristics of locations on a display of the computing device where the application can display advertisement information.

6. The method of claim 1 wherein the file specifies a location and format of a data store residing on the computing device and shared by the application and an ad-wrapper residing on the computing device, wherein modifying the file includes storing the additional advertising information in the specified location of the shared data store.

7. The method of claim 6 including executing the application wherein, during execution, the application examines the modified file to obtain information about the shared data store, retrieves the additional advertisement information from the shared data store, and displays the additional advertisement information.

8. The method of claim 1 wherein the file specifies a location and format of a data store residing on the computing device and shared by the application and an ad-wrapper residing on the computing device, wherein modifying the file includes storing information about how to obtain the additional advertisement information from an external service.

9. The method of claim 8 including executing the application wherein, during execution, the application retrieves the information from the shared data store about how to obtain the additional advertisement information from the external service, obtains the additional advertisement information from the external service, and displays the additional advertisement information.

10. The method of claim 1 wherein the file indicates the ability of the application to contact an advertisement service to receive or transmit advertisement information.

11. The method of claim 1 wherein the file indicates the ability of the application to allow a user to interact with advertisement information displayed on the computing device.

12. The method of claim 1 wherein the file specifies a type of advertisement metric to be tracked.

13. The method of claim 1 including subsequently executing the application wherein, during execution, the application examines the modified file to obtain instructions about how and where to display the additional advertisement information during execution, the method further including displaying the additional advertisement information in accordance with the instructions.

14. The method of claim 13 wherein, during execution of the application, the application examines the modified file to obtain instructions about how and where to report advertisement usage metrics, the method further including reporting advertisement usage metrics in accordance with the instructions.

15. The method of claim 14 wherein the advertisement usage metrics are stored by the application in a data store shared by the application and an ad-wrapper residing on the computing device, and wherein the advertisement usage metrics subsequently are retrieved from the shared data store by the ad wrapper and sent to an external service.

16. The method of claim 1 wherein modifying the file includes incorporating information into the file to indicate to the application a type of integration of advertisement information is to be used.

17. The method of claim 1 including subsequently executing the application and displaying advertisement information on the computing device during execution of the application based on the additional advertisement information.

18. The method of claim 17 including:
receiving user input indicating selection of the application for execution;
displaying advertisement information on the computing device either before executing the application, after executing the application, or both before and after executing the application.

19. The method of claim 18 wherein the additional advertisement information displayed during execution of the application complements the advertisement information displayed before or after executing the application.

20. The method of claim 1 wherein the computing device is a mobile computing device.

21. The method of claim 20 wherein the mobile device is one of the following: a mobile phone, a personal digital assistant (PDA), a smart phone, a digital music player, or a laptop computer.

22. An article comprising a machine-readable medium that stores machine-executable instructions for causing a machine to:
perform an advertisement wrapping process with respect to an application prior to installation on a computing device;
examine contents of a file, which is associated with the application, during the advertisement wrapping process; and
modify contents of the file during the advertisement wrapping process to make additional advertisement information available to the application during execution on the computing device.
